(19) United States
(12) Patent Application Publication
(10) Pub. No.: US 2013/0153376 A1
(43) Pub. Date: Jun. 20, 2013

(54) Inertia Micro-Switch

(71) Applicants: Li-Tin Chiang, Taipei City (TW); Kuei-Ju Lee, New Taipei City (TW)

(72) Inventors: Li-Tin Chiang, Taipei City (TW); Kuei-Ju Lee, New Taipei City (TW)

(73) Assignee: Chung-Shan Institute of Science and Technology, Armaments, Bureau, Ministry of National Defense, Taoyuan County (TW)

(21) Appl. No.: 13/437,190

(22) Filed: Apr. 2, 2012

(30) Foreign Application Priority Data
Dec. 20, 2011 (TW) 100147281

(51) Int. Cl. H01H 35/14

(52) U.S. Cl. 200/61.53

(57) ABSTRACT

An inertia micro-switch includes a shell, a cell unit and an actuator. The shell includes a drum placed between an upper unit and a lower unit. The cell unit is placed in the shell. The actuator includes a housing unit, a lower conductive rod, two movable elements and a hit-taking unit. The housing unit is placed in the vicinity of the cell unit in the shell. The lower conductive rod is placed in the housing unit and connected to the cell unit. The movable elements are placed in the housing unit. The hit-taking unit moves the movable elements and hence contacts the lower conductive rod when it takes a hit.

### BACKGROUND OF INVENTION

1. Field of Invention

The present invention relates to a micro-switch and, more particularly, to an inertia micro-switch for turning an open loop into a closed loop when it takes a hit.

2. Related Prior Art

Inertia micro-switches are used in various fields. An inertia micro-switch is used to turn an open loop into closed loop when it senses acceleration higher than a threshold. A typical inertia micro-switch includes a first terminal, a second terminal isolated from the first terminal, a spring connected to the first terminal, and an inertia block or weight connected to the spring. When the inertia micro-switch is subjected to acceleration higher than a threshold, the inertia block, which is connected to the spring, moves to the external terminal because of inertia. Thus, the first terminal is brought into contact with the second terminal. That is, the inertia micro-switch is turned from an open loop into a closed loop. The inertia micro-switch often fails because the movement is interfered with.

As disclosed in Taiwanese Patent No. 340229, an inertia micro-switch includes a spring, an impedance element, a weight and a contact element. The spring is twisted, instead of extended or compressed, to turn the inertia micro-switch into a closed loop from an open loop as the inertial micro-switch is subjected to acceleration higher than a threshold. The inertial micro-switch is sensitive for acceleration higher than a low threshold. As the acceleration is stopped, the inertia micro-switch is turned back into an open loop from a closed loop to stop a current.

Alternatively, a reserve battery can be used as a power supply in a fuse. The reserve battery includes supporting elements for supporting a bottle for containing electrolytic liquid. When the reserve battery is subjected to acceleration higher than a threshold, the supporting elements fail to stand the inertia of the bottle so that the bottle is moved and broken in the reserve battery. The electrolytic liquid flows from the broken bottle and fills the reserve battery. Hence, a current and voltage is generated. The reserve battery is inevitably broken in a test procedure. Hence, the reserve battery cannot be tested and used repeatedly. Moreover, the cost of the reserve battery is expensive.

The present invention is therefore intended to obviate or at least alleviate the problems encountered in prior art.

### SUMMARY OF INVENTION

It is the primary objective of the present invention to provide a reliable, inexpensive inertia micro-switch which can be turned into a closed loop from an open loop in a test and then returned for use.

To achieve the foregoing objective, the inertia micro-switch includes a shell, a cell unit and an actuator. The shell includes a drum placed between an upper unit and a lower unit. The cell unit is placed in the shell. The actuator includes a housing unit, a lower conductive rod, two balls elements and a hit-taking unit. The housing unit is placed in the vicinity of the cell unit in the shell. The lower conductive rod is placed in the housing unit and connected to the cell unit. The balls are placed in the housing unit. The hit-taking unit includes a lower spring, an inertia ring, an upper conductive rod and an upper spring. The inertia ring is biased by the lower spring. The upper conductive rod is movably placed in the housing unit. The upper spring includes an end connected to the upper conducive rod and another end connected to the housing unit. The upper conductive rod moves the balls and contacts the lower conductive rod when the hit-taking unit takes a hit.

In an aspect, the upper unit includes an upper cover, an upper lead and fasteners for connecting the upper cover to the drum.

In another aspect, the lower unit includes a lower cover, a lower lead and fasteners for connecting the lower cover to the drum.

In another aspect, the cell unit includes Li—H cells or Ni—H cells.

In another aspect, the cell unit further includes cell-contacting elements in contact with the cells.

In another aspect, the housing unit includes a cylinder, a connector, an upper lining and a lower lining. The connector is connected to the cylinder. The upper lining is placed in the cylinder. The lower lining is placed in the cylinder. The lower lining is made of an isolative material.

In another aspect, the hit-taking unit is not in contact with the lower conductive rod before it takes a hit.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of an inertia micro-switch according to the preferred embodiment of the present invention;

FIG. 2 is a perspective view of the inertia micro-switch shown in FIG. 1;

FIG. 3 is an enlarged cross-sectional view of an actuator of the inertia micro-switch shown in FIG. 2; and

FIG. 4 is an enlarged cross-sectional view of the inertia micro-switch in another position than shown in FIG. 3.

### DETAILED DESCRIPTION OF PREFERRED EMBODIMENT

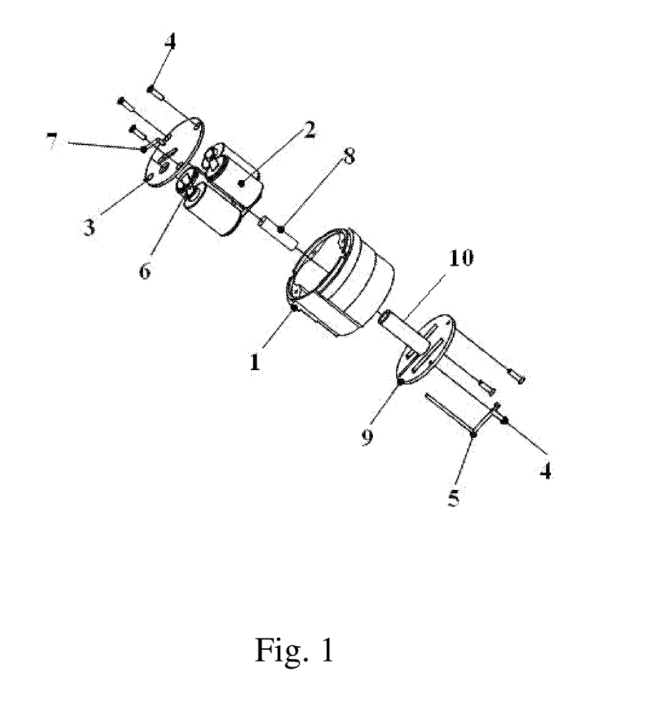

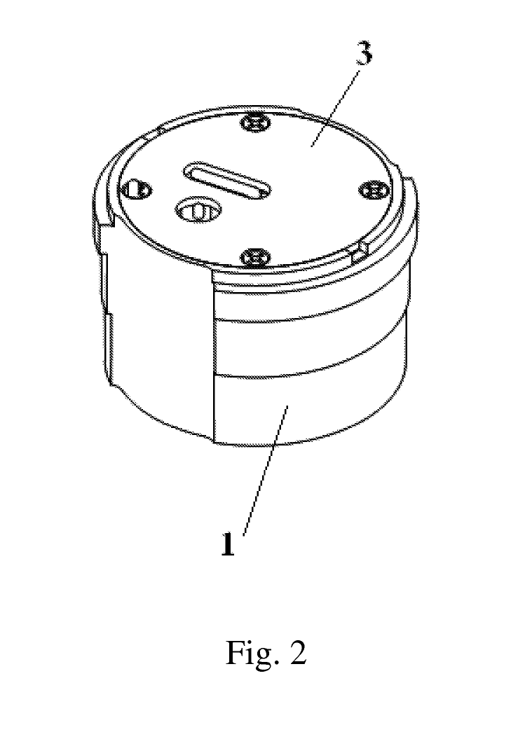

Referring to FIGS. 1 and 2, there is shown an inertia micro-switch according to the preferred embodiment of the present invention. The inertia micro-switch includes a drum 1, a cell unit, an actuator 8, an upper unit and a lower unit.

The upper unit includes an upper cover 3 and an upper lead 7. The upper cover 3 is attached to an upper end of the drum 1 by fasteners 4. The upper lead 7 is connected to or inserted through the upper cover 3.

The lower unit includes a lower cover 9, a lower lead 5 and a sleeve 10. The lower cover 9 is attached to a lower end of the drum 1 by other fasteners 4. The lower lead 5 is connected to or inserted through the lower cover 9. The sleeve 10 is formed on a side of the lower cover 9.

The cell unit is placed in the drum 1. The cell unit includes four Li—H or Ni—H cells 2 and two cell-contacting elements 6. The actuator 8 is placed in the sleeve 10, in the vicinity of the cell unit.

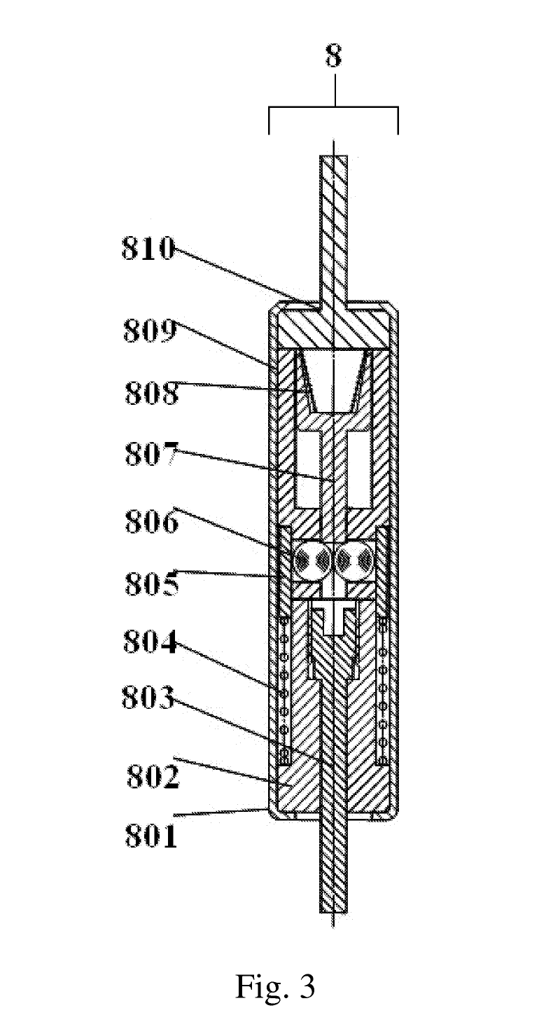

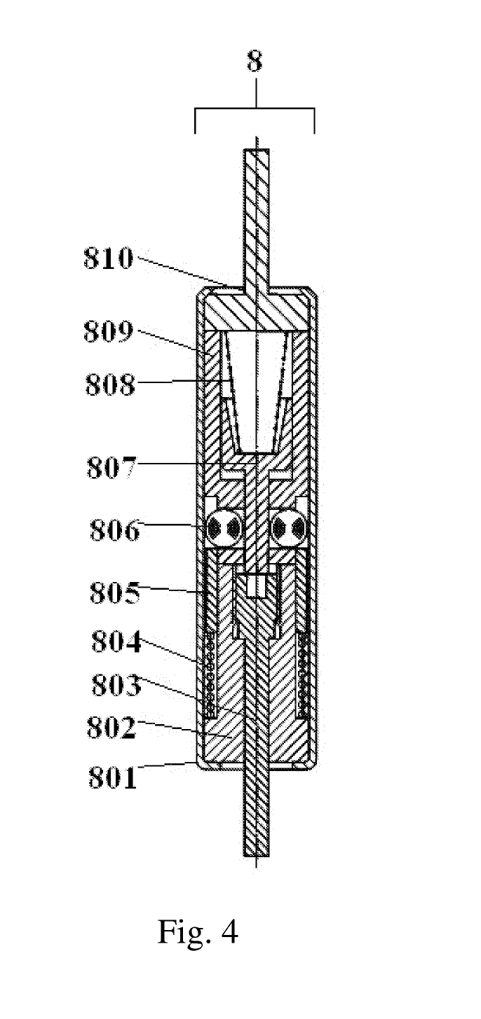

Referring to FIGS. 3 and 4, the actuator 8 includes a housing unit and a hit-taking unit. The hit-taking unit is placed in the housing unit. The housing unit includes a cylinder 801, a connector 810, an upper lining 809 and a lower lining 802. The lower lining 802 is made of an isolative material. The hit-taking unit includes a lower conductive rod 803, a lower spring 804, an inertia ring 805, two balls 806, an upper conductive rod 807 and an upper spring 808.

The lower lining 802 is placed in the cylinder 801. The lower conductive rod 803 is inserted through the lower lining 802 and electrically connected to the cell unit. The lower spring 804 and the inertia ring 805 are provided on the lower lining 802. The balls 806 are placed in the inertia ring 805. The upper lining 809 is placed in the cylinder 801. The upper conductive rod 807 is placed in the upper lining 809. The connector 810 is connected to the shell 810. The upper spring 808 includes an end connected to the connector 810 and another end connected to the upper conductive rod 807.

Referring to FIG. 3, normally, the inertia ring 805 keeps the balls 806 in contact with each other. Normally, the upper conductive rod 807 is separated from the connective rod 803 by the balls 806.

Referring to FIG. 4, as the inertia micro-switch is subjected to acceleration higher than a threshold, the inertia ring 805 moves downward and compresses the lower spring 804. The upper conductive rod 807 pushes open the balls 806 and contacts the lower conductive rod 803. Thus, the inertia micro-switch is turned into a closed loop from an open loop.

The inertia micro-switch can be turned upside down. Thus, the inertia micro-switch is turned back into an open loop shown in FIG. 3 from a closed loop shown in FIG. 4.

The inertia micro-switch can be used as a fuse in a medium or large caliber mortar, howitzer or rocket. Alternatively, the inertia micro-switch can be used as a hit sensor in a vehicle.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An inertia micro-switch including:
a shell including an upper unit, a lower unit and a drum 1 placed between the upper and lower units;
a cell unit placed in the shell; and
an actuator 8 including:
a housing unit placed in the vicinity of the cell unit in the shell;
a lower conductive rod 803 placed in the housing unit and connected to the cell unit;
two movable elements 806 placed in the housing unit; and
a hit-taking unit for moving the movable elements 806 and hence contacting the lower conductive rod 803.

2. The inertia micro-switch according to claim 1, wherein the upper unit includes an upper cover 3, an upper lead 7 and fasteners 4 for connecting the upper cover 3 to the drum 1.

3. The inertia micro-switch according to claim 1, wherein the lower unit includes a lower cover 9, a lower lead 5 and fasteners 4 for connecting the lower cover 9 to the drum.

4. The inertia micro-switch according to claim 1, wherein the cell unit includes at least one cell 2 selected from the group consisting of Li—H cells and Ni—H cells.

5. The inertia micro-switch according to claim 4, wherein the cell unit further includes cell-contacting elements 6 in contact with the cells 2.

6. The inertia micro-switch according to claim 1, wherein the housing unit includes:
a cylinder 801;
a connector 810 connected to the cylinder 801;
an upper lining 809 placed in the cylinder 801; and
a lower lining 802 placed in the cylinder 801.

7. The inertia micro-switch according to claim 6, wherein the lower lining 802 is made of an isolative material.

8. The inertia micro-switch according to claim 1, wherein the hit-taking unit includes:
a lower spring 804;
an inertia ring 805 biased by the lower spring 804;
an upper conductive rod 807 movably placed in the housing unit; and
an upper spring 808 connected to the upper conducive rod 807.

9. The inertia micro-switch according to claim 1, wherein the movable elements 806 are balls.

10. The inertia micro-switch according to claim 1, wherein the hit-taking unit is not in contact with the lower conductive rod 803 before it takes a hit.

11. An inertia micro-switch including:
a shell including an upper unit, a lower unit and a drum 1 placed between the upper and lower units;
a cell unit placed in the shell; and
an actuator 8 including:
a housing unit placed in the vicinity of the cell unit in the shell;
a lower conductive rod 803 placed in the housing unit and connected to the cell unit;
two balls 806 placed in the housing unit; and
a hit-taking unit including:
a lower spring 804;
an inertia ring 805 biased by the lower spring 804;
an upper conductive rod 807 movably placed in the housing unit, wherein the upper conductive rod 807 moves the balls 806 and hence contacts the lower conductive rod 803 when the hit-taking unit takes a hit; and
an upper spring 808 including an end connected to the upper conducive rod 807 and another end connected to the housing unit.

12. The inertia micro-switch according to claim 11, wherein the upper unit includes an upper cover 3, an upper lead 7 and fasteners 4 for connecting the upper cover 3 to the drum 1.

13. The inertia micro-switch according to claim 11, wherein the lower unit includes a lower cover 9, a lower lead 5 and fasteners 4 for connecting the lower cover 9 to the drum.

14. The inertia micro-switch according to claim 11, wherein the cell unit includes at least one cell 2 selected from the group consisting of Li—H cells and Ni—H cells.

15. The inertia micro-switch according to claim 14, wherein the cell unit further includes cell-contacting elements 6 in contact with the cells 2.

16. The inertia micro-switch according to claim 11, wherein the housing unit includes:
a cylinder 801;
a connector 810 connected to the cylinder 801;
an upper lining 809 placed in the cylinder 801; and
a lower lining 802 placed in the cylinder 801, wherein the lower lining 802 is made of an isolative material.

17. The inertia micro-switch according to claim 11, wherein the hit-taking unit is not in contact with the lower conductive rod 803 before it takes a hit.

18. A method for operating an inertia micro-switch including the steps of:
connecting a lower conductive rod to a cell unit;
providing an inertia ring for moving downward and compressing a spring when the inertia ring takes a hit; and
providing an upper conductive rod for moving downward, pushing open two balls normally restrained by the inertia ring, and hence contacting the lower conductive rod.
